(19) United States
(12) Patent Application Publication
(10) Pub. No.: US 2025/0058401 A1
(43) Pub. Date: Feb. 20, 2025

(54) ARC PROCESSING TORCH WITH CONSUMABLE

(71) Applicant: The ESAB Group Inc., North Bethesda, MD (US)

(72) Inventors: Andrew Raymond, Lebanon, NH (US); Jeffrey S. Underhill, Piermont, NH (US)

(21) Appl. No.: 18/449,113

(22) Filed: Aug. 14, 2023

(51) Int. Cl. B23K 9/29; B23K 9/173

(52) U.S. Cl. CPC B23K 9/295; B23K 9/1735

(57) ABSTRACT

An arc processing torch includes a torch body having a first interface surface and a second interface surface to form a stepped profile defining a cavity. The arc processing torch also has a plurality of consumable components including a first consumable component configured to be positioned within the cavity to engage with the first interface surface and a second consumable component configured to be positioned within the cavity to engage with the second interface surface. The first consumable component and the second consumable component are configured to independently engage with the first interface surface and the second interface surface, respectively.

### TECHNICAL FIELD

The present disclosure relates to the field of arc processing torches, and in particular, to an arc processing torch with improved component engagement features.

### BACKGROUND

Arc processing torches may be used to cut or weld materials. For example, an arc processing torch includes a torch body and a consumable assembly configured to couple to the torch body. During operation of the arc processing torch, the torch body is configured to receive a fluid and direct the fluid to the consumable assembly to generate an arc used for a cutting or welding process.

The consumable assembly is composed of many different components or parts. While the consumable assembly is coupled to the torch body, the components are arranged to enable operation of the arc processing torch, such as to define a flow path through which fluid received from the torch body may flow. To achieve this, the components may have different features configured to engage with one another to position each component relative to other components and/or the torch body. Unfortunately, it may be difficult and/or complex to manufacture each component and/or to secure each component to one another to provide a consumable assembly that operates desirably. For instance, certain components may be misaligned with one another and/or with the torch body.

### SUMMARY

The present disclosure is directed towards an arc processing torch including a plurality of consumable components that are configured to independently engage a respective surface of a torch body; a method for inserting consumable components within a cavity defined by a torch body of an arc processing torch; and an arc processing torch including a torch body with surfaces and consumable components configured to engage with the surfaces.

According to one example embodiment, an arc processing torch includes a torch body having a first interface surface and a second interface surface to form a stepped profile defining a cavity. The arc processing torch also has a plurality of consumable components including a first consumable component configured to be positioned within the cavity to engage with the first interface surface and a second consumable component configured to be positioned within the cavity to engage with the second interface surface. The first consumable component and the second consumable component are configured to independently engage with the first interface surface and the second interface surface, respectively.

According to another example embodiment, a method of assembling an arc processing torch includes inserting a first consumable component of the arc processing torch within a cavity defined by a torch body of the arc processing torch to position the first consumable component against a first surface of the torch body, inserting a second consumable component of the arc processing torch within the cavity to position the second consumable component against a second surface of the torch body, and inserting a third consumable component of the arc processing torch within the cavity to position the third consumable component against a third surface of the torch body.

According to yet another embodiment, an arc processing torch includes a torch body that with a first interface surface, an axial surface that extends distally from the first interface surface, and a second interface surface that extends laterally beyond the first interface surface. The arc processing torch also includes a first consumable component configured to engage with the first interface surface and a second consumable component configured to engage with the second interface surface.

Other systems, methods, features, and advantages will be, or will become, apparent to one with skill in the art upon examination of the following figures and detailed description. All such additional systems, methods, features, and advantages are included within this description, are within the scope of the claimed subject matter.

### BRIEF DESCRIPTION OF THE DRAWINGS

The arc processing torch presented herein may be better understood with reference to the following drawings and description. It should be understood that the elements in the figures are not necessarily to scale and that emphasis has been placed upon illustrating the principles of the consumables. In the figures, like-referenced numerals designate corresponding parts throughout the different views.

FIG. 1A is a perspective view of an automated cutting system that may utilize the features presented herein, according to an example embodiment of the present disclosure.

FIG. 1B is a perspective view of an automated cutting head that may be included in the automated cutting system illustrated in FIG. 1A, according to an example embodiment of the present disclosure.

FIG. 1C is a schematic, cross-sectional view of an end portion of an arc processing torch, according to an example embodiment of the present disclosure.

FIG. 2 is a schematic, cross-sectional, exploded view of an arc processing torch, according to an example embodiment of the present disclosure.

FIG. 3 is a schematic, cross-sectional view of a consumable component aligned within a torch body of an arc processing torch, according to an example embodiment of the present disclosure

FIG. 4 is a perspective cross-sectional view of a torch body of an arc processing torch, according to an example embodiment of the present disclosure.

FIG. 5 is a front cross-sectional view of an arc processing torch with a consumable assembly coupled to a torch body, according to an example embodiment of the present disclosure.

FIGS. 6A-6C are perspective views of a portion of at least a portion of a consumable assembly of an arc processing torch, according to an example embodiment of the present disclosure.

FIG. 7 is a flowchart depicting a method of assembling an arc processing torch, according to an example embodiment of the present disclosure.

### DETAILED DESCRIPTION

The following description is not to be taken in a limiting sense but is given solely for the purpose of describing the broad principles of the disclosure. Embodiments of the disclosure will be described by way of example, with reference to the above-mentioned drawings showing elements and results according to the present disclosure. For example, the techniques and features discussed herein may be applied to a plasma cutting torch, a welding torch, or any other suitable arc processing torch.

That is, the present disclosure is generally directed to an arc processing torch configured to perform a cutting and/or welding operation. Consequently, the arc processing torch includes a torch body configured to couple to a consumable assembly. Also, the arc processing torch is configured to receive electric power and/or fluid flow(s) from one or more sources, such as a power supply. During operation of the arc processing torch, the torch body receives the electric power and flow(s) of fluid and directs the electric power and fluid flow to the consumable assembly to generate an arc to perform the cutting and/or welding operation. In some embodiments, the consumable assembly includes multiple separate components, such as a cartridge body, an electrode, a distributor, a nozzle, and/or a shield.

It may be difficult to provide a consumable assembly using multiple separate components to operate the arc processing torch desirably. For example, misalignment between the components and the torch body may reduce effective operation of the arc processing torch, such as by causing the arc processing torch to cut or weld inaccurately. Additionally or alternatively, misalignment may reduce the lifespan of consumable components, e.g., if an arc attaches to a misaligned consumable instead of exiting an orifice, as intended.

In some embodiments, the consumable components include different features configured to engage with one another. However, such features may deviate from their design dimensions, e.g., due to tolerancing issues during manufacturing and/or due to wear over time, or otherwise may not cause the components to be positioned in desirable alignment with one another and/or with the torch body. The misalignments may be further exacerbated if multiple components have positions that are dependent on one another (e.g., components that are stacked on top of one another). Indeed, misalignments between components that are coupled to one another may combine to reduce an overall alignment of the consumable assembly with the torch body. For instance, misalignment associated with a first component may cause subsequent misalignment associated with a second component coupled to the first component. Thus, potential inaccuracies in welds/cuts due to component misalignment(s) may compound.

Further, it may be difficult, costly, and/or complex to manufacture the components having features with precise dimensions that reduce potential misalignment. Additionally or alternatively, it may be difficult, complex, and/or tedious to arrange (e.g., manually position) the components in a desirable manner (e.g., to achieve a desirable alignment) to assemble the consumable assembly. Moreover, wear and/or deformation of the components over time may cause undesirable misalignment between the components. In certain embodiments, additional operations (e.g., machining) to address the misalignment of components may be performed, but such operations may increase manufacturing time and/or cost, thereby reducing efficiency of operation of the arc processing torch.

Thus, limiting potential misalignment between components of the arc processing torch may improve operation of the arc processing torch. Accordingly, embodiments of the present disclosure are directed to consumable components that are configured to independently align with the torch body. That is, each consumable component may be separately engaged and aligned with the torch body. Accordingly, engagement and alignment of one consumable component with the torch body will not affect engagement and alignment of another consumable component with the torch body. In this manner, desirable positioning of the consumable components may be more easily achieved.

Put another way, a consumable component may be aligned with the torch body regardless of the positioning of other consumable components with respect to the torch body, because the alignment of the consumable components with the torch body may be independent of the positioning of the consumable components relative to one another. Thus, even if one of the consumable components is misaligned with the torch body (e.g., caused by imprecise manufacturing or assembly), other consumable components may remain aligned with the torch body. That is, misalignments do not compound. Consequently, effective operation of the arc processing torch resulting from desirable positioning of the consumable components may also be more easily achieved.

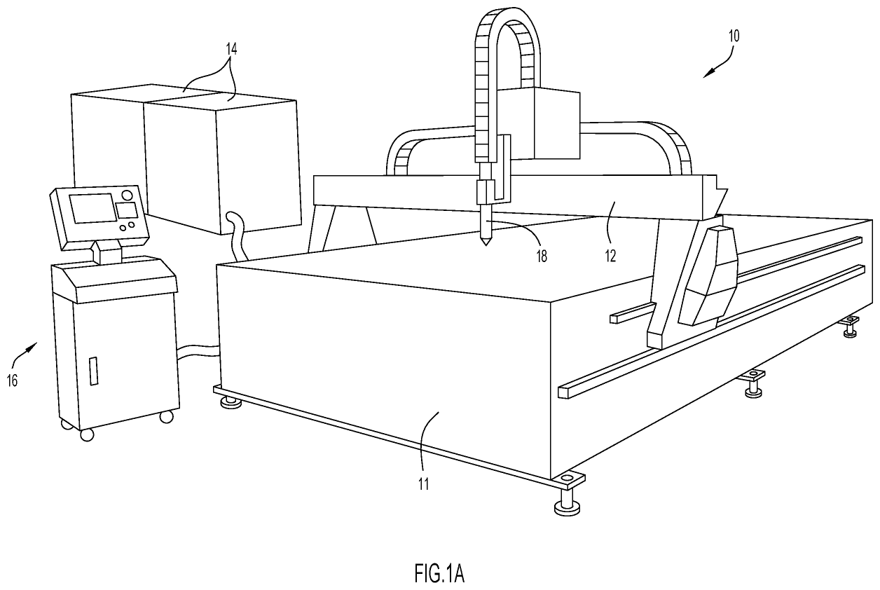

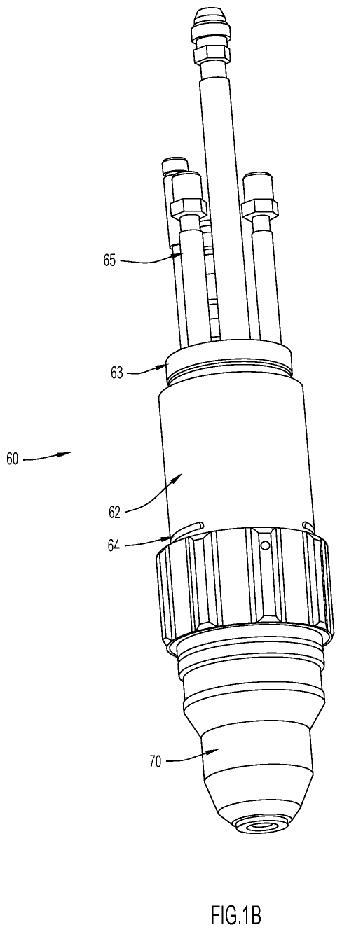

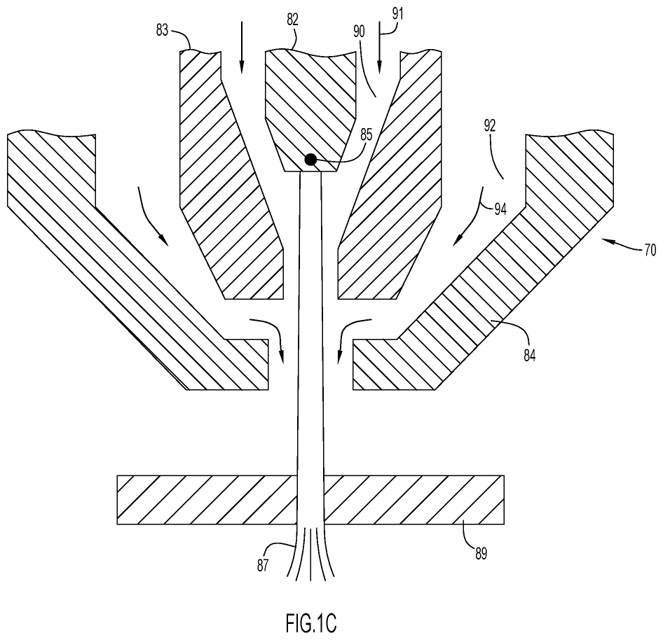

FIG. 1A illustrates an example embodiment of an automated cutting system 10 (e.g., an automated plasma cutting system) that may execute the techniques presented herein. That is, FIG. 1A illustrates an example embodiment of an automated cutting system 10 that may utilize the aligned consumable components presented herein. However, this automated cutting system 10 is merely presented by way of example, and the techniques presented herein may also be executed by manual cutting systems, manual welding systems, automated welding systems, and/or automated or mechanized cutting systems that differ from the automated cutting system 10 of FIG. 1A (e.g., any robotic or partially robotic cutting system). That is, any desired arc processing torch system may utilize the consumable presented herein, and the automated cutting system 10 illustrated in FIG. 1A is provided for illustrative purposes.

At a high-level, the automated cutting system 10 includes a table 11 configured to receive a workpiece (not shown), such as, but not limited to, sheets of metal. The automated cutting system 10 also includes a positioning system 12 that is mounted to the table 11 and configured to translate or move along the table 11. At least one automated arc processing torch 18 is mounted to the positioning system 12 and, in some embodiments, multiple automated arc processing torches 18 may be mounted to the positioning system 12. The positioning system 12 may be configured to move, translate, and/or rotate the automated arc processing torch 18 in any direction (e.g., to provide movement in all degrees of freedom).

Additionally, at least one power supply 14 is operatively connected to the automated arc processing torch 18 and configured to supply (or at least control the supply of) electrical power and flows of one or more fluids to the automated arc processing torch 18 for operation. Finally, a controller or control panel 16 is operatively coupled to and in communication with the automated arc processing torch 18, the one or more power supplies 14, and the positioning system 12. The controller 16 may be configured to control the operations of the automated arc processing torch 18, one or more power supplies 14, and/or the positioning system 12, either alone or in combination with the one or more power supplies 14.

In at least some embodiments, the one or more power supplies 14 meter one or more flows of fluid received from one or more fluid supplies before or as the one or more power supplies 14 supply fluid to the automated arc processing torch 18 via one or more cable conduits. Additionally or alternatively, the automated cutting system 10 may include a separate fluid supply unit (not shown) or units that can provide one or more fluids to the automated arc processing torch 18 independent of the one or more power supplies 14. To be clear, as used herein, the term “fluid” shall be construed to include a gas, a liquid, or a liquid/gas mixture. The one or more power supplies 14 may also condition, meter, and supply power to the automated arc processing torch 18 via one or more cables, which may be integrated with, bundled with, or provided separately from cable conduits for fluid flows. Additional cables for data, signals, and the like may also interconnect the controller 16, the automated arc processing torch 18, the power supply 14, and/or the positioning system 12. Any cable or cable conduit/hose included in the automated cutting system 10 may be of any length. Moreover, each end of any cable or cable conduit/hose may be connected to components of the automated cutting system 10 via any connectors now known or developed hereafter (e.g., via releasable connectors).

FIG. 1B illustrates an example embodiment of an automated cutting head 60 that may be used with an automated cutting system executing the techniques presented herein (e.g., the automated cutting system 10 of FIG. 1A). As can be seen, the cutting head 60 includes a body 62 that extends from a first end 63 (e.g., a connection end 63) to a second end 64 (e.g., an operating or operative end 64). The connection end 63 of the body 62 may be coupled (in any manner now known or developed hereafter) to an automation support structure (e.g., a cutting table, robot, gantry, etc., such as positioning system 12). Meanwhile, conduits 65 extending from the connection end 63 of the body 62 may be coupled to like conduits in the automation support structure (e.g., positioning system 12) to connect the automated cutting head 60 to a power supply, one or more fluid supplies, a coolant supply, and/or any other components supporting automated cutting operations.

At the other end, the operative end 64 of the body 62 may receive interchangeable components, including a consumable component stack 70, that facilitate cutting operations. For simplicity, FIGS. 1A and 1B do not illustrate connections portions of the body 62 that allow consumable components 70 to connect to the torch body 62 in detail. However, it should be understood that the cutting consumables 70, such as those illustrated in the figures, may be coupled to a torch body 62 in any manner. Moreover, to be clear, the consumable stacks depicted in the figures (with an external and cross-sectional views) are merely representative of consumable stacks that may be used with an automated torch head 60 to implement the techniques presented herein. Similarly, it is to be understood that any unillustrated components that are typically included in a torch, such as components that facilitate cutting operations, may (and, in fact, should) be included in a torch executing example embodiments of the present application.

Now turning to FIG. 1C, this figure is a simplified/schematic illustration of the consumable stack 70 of FIG. 1B. As mentioned, FIG. 1C illustrates select components or parts that allow for a clear and concise illustration of the techniques presented herein. Thus, in FIG. 1C, an electrode 82, a nozzle 83, and a shield cap 84 of the consumable stack 70 are depicted. As can be seen, the electrode 82 is disposed at a center of the consumable stack 70 and includes an emitter 85 (e.g., formed from hafnium, tungsten, and/or other emissive materials) at a distal end portion thereof. The nozzle 83 is generally positioned around the electrode 82. In some embodiments, the nozzle 83 is installed after the electrode 82. The nozzle 83 may be spaced from the electrode 82, or at least a distal portion of the nozzle 83 may be spaced apart from the distal portion of the electrode 82.

The shield 84 is positioned radially exteriorly of the nozzle 83 and is spaced apart from the nozzle, at least at its distal end. In some embodiments, the shield 84 is installed around an installation flange of the nozzle 83 in order to secure the nozzle 83 and the electrode 82 in place at (and in axial alignment with) an operating end of the torch body. Additionally or alternatively, the nozzle 83 and/or the electrode 82 can be secured or affixed to a torch body in any desirable manner, such as by mating threaded sections included on the torch body with corresponding threads included on the components. In accordance with embodiments discussed herein, each of the electrode 82, the nozzle 83, and/or the shield 84 is configured to engage with the torch body. For example, the electrode 82, the nozzle 83, and/or the shield 84 are configured to be independently positioned in engagement with the torch body. Such arrangement of the electrode 82, the nozzle 83, and/or the shield 84 may reduce potential misalignments and/or simplify assembly to provide the consumable stack 70.

In use, an arc processing torch is configured to emit an arc 87 between the electrode 82 and a workpiece 89 to which a work lead associated with a power supply is attached (not shown). As shown in FIG. 1C, the nozzle 83 is spaced a distance away from the electrode 82 so that a processing fluid flow channel 90 is disposed therebetween. During welding, piercing, or cutting operations, a processing fluid 91 flows through the processing fluid flow channel 90. The shield 84 is also spaced a distance away from the nozzle 83 so that a shield flow channel 92 is disposed between the shield 84 and the nozzle 83. A shield fluid 94 flows through the shield flow channel 92 during at least a portion of the time the arc processing torch is operated. In at least some instances, the shield fluid 94 and the working fluid 91 include the same fluid (e.g., different portions that were originally part of the same fluid flow).

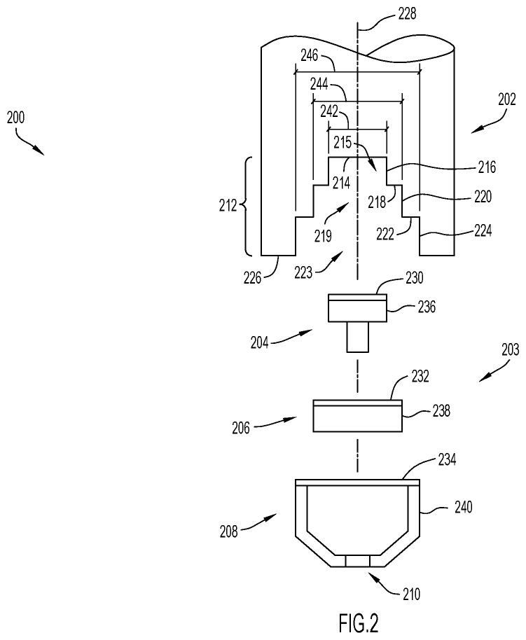

FIG. 2 is a schematic, cross-sectional, exploded view of a portion of an arc processing torch 200 (e.g., a plasma cutting torch). The arc processing torch 200 includes a torch body 202 and a consumable assembly 203 composed of a first consumable component 204, a second consumable component 206, and a third consumable component 208. As an example, the first consumable component 204 may be or include an electrode, the second consumable component 206 may be or include a distributor, and the third consumable component 208 may be or include a nozzle. In an assembled configuration of the consumable assembly 203, the first consumable component 204 extends through an opening of the second consumable component 206, and each of the first consumable component 204 and the second consumable component 206 extends through an opening of the third consumable component 208. Thus, the second consumable component 206 surrounds the first consumable component 204 and the third consumable component 208 surrounds each of the first consumable component 204 and the second consumable component 206 in the assembled configuration.

During operation of an arc processing torch 200, the torch body 202 is configured to receive electric power and fluid and direct the electric power and fluid to at least a portion of the consumable assembly 203. For example, the first consumable component 204 and the third consumable component 208 may be connected to electrical power to generate an electric arc (e.g., a pilot arc) between the first consumable component 204 and the third consumable component 208. Meanwhile, the second consumable component 206 may direct fluid between the first consumable component 204 and the third consumable component 208 to cause the fluid to become ionized via the arc. The fluid may then flow out of the consumable assembly 203 via an orifice 210 of the third consumable component 208 to transfer the arc onto a workpiece.

The torch body 202 includes a stepped profile or configuration defining a cavity 212. To this end, the torch body 202 includes a first interface surface 214, such as a proximate or interior surface, a first axial surface 216 extending distally (e.g., perpendicularly) away from the first interface surface 214. Then, moving distally, the torch body 202 includes a second interface surface 218, such as an intermediate surface, extending laterally (e.g., radially) outward from the first axial surface 216 and a second axial surface 220 extending distally (e.g., perpendicularly) away from the second interface surface 218. Still moving distally, the torch body 202 further includes a third interface surface 222, such as a distal surface, extending laterally (e.g., radially) outward from the second axial surface 220 and, a third axial surface 224 extending distally (e.g., perpendicularly) away from the third interface surface 222. Finally, at least in the depicted embodiment, the torch body 202 includes a fourth interface surface 226, such as an exterior surface, extending laterally (e.g., radially) outward from the third axial surface 224. Accordingly, the first interface surface 214 and the first axial surface 216 cooperatively define a first receptacle 215, the second interface surface 218 and the second axial surface 220 cooperatively define a second receptacle 219, and the third interface surface 222 and the third axial surface 224 cooperatively define a third receptacle 223. However, in other embodiments, the torch body 202 may include any quantity of steps that define any quantity of receptacles and each step may be formed in any desirable manner.

In some embodiments, the first interface surface 214, the second interface surface 218, and/or the third interface surface 222 are centered about one another. That is, each of the first interface surface 214, the second interface surface 218, and/or the third interface surface 222 may be centered around the same axis 228 (e.g., a central axis). As such, the first axial surface 216, the second axial surface 220, and/or the third axial surface 224 may be concentric to the axis 228 and to one another. However, in additional or alternative embodiments, any of the first interface surface 214, the second interface surface 218, and/or the third interface surface 222 may be off-center with one another.

The first consumable component 204, the second consumable component 206, the third consumable component 208 are configured to respectively engage with the first interface surface 214, the second interface surface 218, and the third interface surface 222 in the assembled configuration of the consumable assembly 203. By way of example, a first consumable surface 230 of the first consumable component 204 is configured to engage with the first interface surface 214, a second consumable surface 232 of the second consumable component 206 is configured to engage with the second interface surface 218, and a third consumable surface 234 of the third consumable component 208 is configured to engage with the third interface surface 222.

As is detailed below, in at least some embodiments, the consumable surfaces 230, 232, 234 are configured to engage with the torch body 202 in a manner that temporarily retains consumable components 204, 206, 208 on the torch body 202. Alternatively, the consumable surfaces 230, 232, 234 might fixedly secure to the torch body 202, e.g., via threads, detents, etc. As examples, tolerancing between sides of the consumable components 204, 206, 208 and the axial surfaces 216, 220, 224 may create a friction or interference fit and/or a separate component (not shown) might secure the consumable components 204, 206, 208 to the torch body 202. However, to be clear, the separate component can be used with any desirable arrangement in which the consumable surfaces 230, 232, 234 are engaged with the torch body 202.

Regardless of how (or whether) the consumable surfaces 230, 232, 234 are secured to the torch body 202, in certain embodiments, the first consumable surface 230, the second consumable surface 232, and/or the third consumable surface 234 use face seals (e.g., die cut face seals) configured to block undesirable flow of fluid between the torch body 202 and the consumable components 204, 206, 208 (e.g., to force fluid flow through the second consumable component 206). Thus, the first consumable surface 230, the second consumable surface 232, and/or the third consumable surface 234 may sealingly engage with the respective interface surfaces 214, 218, 222 to cause fluid(s) to flow through the consumable assembly 203 (e.g., instead of around or through consumable assembly 203).

Advantageously, in embodiments where the consumable surfaces 230, 232, 234 use face seals, the torch body 202 and/or consumable assembly 203 may not use separate components (e.g., O-rings) dedicated to enabling desirable fluid flow or block undesirable fluid flow through the consumable assembly 203. The elimination of such components will simplify, thereby improving, production, assembly, and/or maintenance of the consumable assembly 203. Indeed, reducing the quantity of separate components, including dedicated seals, utilized in the consumable assembly 203 may facilitate ease of alignment of the components. Not only can alignment be created without accommodating the additional geometry of separate sealing components, but excluding independent seals (e.g., O-rings) may also remove uncertainty from manufacturing and/or assembly processes. This is because independent seals can compress or shift during assembly and/or over time (e.g., due to wear and deformation), creating potential geometric changes of the sealing components that can result in misalignment.

Still referring to FIG. 2, a first consumable sidewall 236 of the first consumable component 204 is configured to be positioned between (e.g., engage with) opposite sides of the first axial surface 216, a second consumable sidewall 238 of the second consumable component 206 is configured to be positioned between (e.g., engage with) opposite sides of the second axial surface 220, and/or a third consumable sidewall 240 of the third consumable component 208 is configured to be positioned between (e.g., engage with) opposite sides of the third axial surface 224 in the assembled configuration of the consumable assembly 203. In this way, the first receptacle 215 is configured to receive and capture the first consumable component 204, the second receptacle 219 is configured to receive and capture the second consumable component 206, and the third receptacle 223 is configured to receive and capture the third consumable component 208. In certain embodiments, the second consumable component 206 is exterior to the first receptacle 215, and the third consumable component 208 is exterior to both the first receptacle 215 and the second receptacle 219. In any case, the positioning of the consumable components 204, 206, 208 within the first receptacle 215, the second receptacle 219, and the 223, respectively, may align the consumable components 204, 206, 208 in a desirable manner with respect to the torch body 202 and/or with respect to one another.

As such, each of the consumable components 204, 206, 208 may be independently aligned with the torch body 202. For example, first, the first consumable component 204 may engage with the first interface surface 214 of the torch body 202 without having to engage with the second consumable component 206 and/or with the third consumable component 208. Second, the second consumable component 206 may engage with the second interface surface 218 of the torch body 202 without having to engage with the first consumable component 204 and/or with the third consumable component 208. Third, the third consumable component 208 may engage with the third interface surface 222 without having to engage with the first consumable component 204 and/or with the second consumable component 206. In this way, the consumable assembly 203 may be assembled by individually positioning the consumable components 204, 206, 208 within the cavity 212 for engagement with the torch body 202, rather than in engagement with one another (e.g., to otherwise provide an assembled cartridge having a profile that can couple to the torch body 202).

Such engagement between the consumable components 204, 206, 208 and the torch body 202 may also align the consumable components 204, 206, 208 desirably with respect to one another. For example, in the depicted embodiment, the first axial surface 216 defines a first dimension 242 (e.g., a first diameter) that restricts movement of the first consumable component 204 within the first receptacle 215, the second axial surface 220 defines a second dimension 244 (e.g., a second diameter) that restricts movement of the second consumable component 206 within the second receptacle 219, and the third axial surface 224 defines a third dimension 246 (e.g., a third diameter) that restricts movement of the third consumable component 208 within the third receptacle 223. More specifically, the first dimension 242, the second dimension 244, and the third dimension 246 are sized to restrict movement of the consumable components 204, 206, 208 in a manner that positions the consumable components 204, 206, 208 in alignment with one another. Thus, in at least some instances, full alignment can be achieved by carefully manufacturing the dimensions of the torch body 202. That is, the torch body 202 may be manufactured so as to have a geometric range or tolerancing of the first axial surface 216, of the second axial surface 220, and of the third axial surface 224 to maintain alignment between the consumable components 204, 206, 208.

More specifically, with the arrangement of FIG. 2, alignment of the consumable components 204, 206, 208 may be based primarily on the dimensions of the torch body 202 (e.g., the first dimension 242, the second dimension 244, and the third dimension 246). That is, because alignment of the consumable components 204, 206, 208 is effectuated by manufacture/dimensioning of consumable components 204, 206, 208 and subsequent engagement with the torch body 202, the alignment of the consumable components 204, 206, 208 may not be dependent on the relative manufacture/dimensioning of one another. As such, the consumable components 204, 206, 208 may be individually and separately manufactured based primarily on the dimensions of the torch body 202 (e.g., without having to extensively consider the relative dimensions of the consumable components 204, 206, 208).

By way of example, the first consumable component 204 may be manufactured based on dimensions of the first interface surface 214 and/or of the first axial surface 216 of the torch body 202 with which the first consumable component 204 engages, rather than based on an external dimension of the second consumable component 206 and/or of the third consumable component 208. Similarly, the second consumable component 206 may be manufactured based on dimensions of the second interface surface 218 and/or of the second axial surface 220 with which the second consumable component 206 engages, rather than based on an external dimension of the first consumable component 204 and/or of the third consumable component 208. Finally, the third consumable component 208 may be manufactured based on dimensions of the third interface surface 222 and/or of the third axial surface 224 with which the third consumable component 208 engages, rather than based on an external dimension of the first consumable component 204 and/or of the second consumable component 206.

In other words, the consumable components 204, 206, 208 are manufactured to enable corresponding engagement and positioning with respect to the torch body 202, rather than with one another. The alignment of the consumable components 204, 206, 208 being dependent on respective engagement with the torch body 202, rather than on engagement between the consumable components 204, 206, 208, may therefore provide ease of manufacture of the consumable components 204, 206, 208. However, at the same time, in many embodiments (if not all), at least some dimensions (e.g., interior dimensions) of the consumable components 204, 206, 208 may be designed and manufactured relative to one another, e.g., to form fluid paths, electrical connections, and the like, between the consumable components 204, 206, 208.

Because the alignment of the consumable components 204, 206, 208 depends on individual engagement with the torch body 202, rather than coupling of the consumable components 204, 206, 208 with one another (e.g., in addition to engagement with the torch body 202), misalignments associated with the consumable components 204, 206, 208 may be reduced or limited. For instance, misalignments may not compound. As an example, even if one of the consumable components 204, 206, 208 is misaligned with the torch body 202, a remainder of the consumable components 204, 206, 208 may be desirably aligned with the torch body 202 to enable the arc processing torch 200 to operate relatively effectively despite the presence of a misaligned consumable component.

The independent engagement and alignment with the torch body 202 may also facilitate greater ease of assembly of the consumable assembly 203. For example, the first consumable component 204 may be positioned in engagement with the first interface surface 214 and/or with the first axial surface 216 regardless of whether the second consumable component 206 and/or the third consumable component 208 are positioned in engagement with the torch body 202. Additionally or alternatively, the second consumable component 206 may be positioned in engagement with the second interface surface 218 and/or with the second axial surface 220 regardless of whether the first consumable component 204 and/or the third consumable component 208 are positioned in engagement with the torch body 202. Likewise, the third consumable component 208 may be positioned in engagement with the third interface surface 222 and/or with the third axial surface 224 regardless of whether the first consumable component 204 and/or the second consumable component 206 are positioned in engagement with the torch body 202.

Accordingly, the consumable components 204, 206, 208 may be separately and individually coupled to the torch body 202 to be aligned with one another. In other words, in at least some embodiments, any of the consumable components 204, 206, 208 may be coupled to the torch body 202 without having to initially couple another of the consumable components 204, 206, 208 to the torch body 202 and/or to one another. That said, in other embodiments, consumable components 204, 206, 208 may be coupled to the torch body 202 in a specific order (e.g., the first consumable component 204, then the second consumable component 206, then the third consumable component 208).

In certain embodiments, the first consumable component 204, the second consumable component 206, and/or the third consumable component 208 may also include features that further facilitate coupling of the consumable assembly 203 to the torch body 202. For example, one or more of consumable components 204, 206, 208 may have features that provide temporary or initial securement with the torch body 202. This temporary engagement may allow consumable components 204, 206, and/or 208 to be arranged in desirable positions with respect to the torch body 202 during installation of the consumable components 204, 206, and/or 208 onto torch body 202. Additionally or alternatively, the features may create a more durable coupling between the consumable assembly 203 and the torch body 202.

As an example of such features, in some instances each of the first consumable component 204 (e.g., the first consumable surface 230), the second consumable component 206 (e.g., the second consumable surface 232), the third consumable component 208 (e.g., the third consumable surface 234), and the torch body 202 (e.g., the first interface surface 214, the first axial surface 216, the second interface surface 218, the second axial surface 220, the third interface surface 222, the third axial surface 224) may be composed of a magnetic material. Thus, each of the consumable components 204, 206, 208 may be configured to magnetically engage with the torch body 202 to at least temporarily retain the consumable components 204, 206, 208 in a desirable alignment with respect to the torch body 202 and/or with respect to one another. Other features that may be used to initially secure the consumable components 204, 206, 208 to the torch body 202 include an interference fit (e.g., a slip fit), a detent pin, and/or a collet lock.

Regardless of the feature used to hold the consumable components 204, 206, 208 against the torch body 202, such retention of the consumable components 204, 206, 208 may enable a more permanent or durable coupling feature, such as an adhesive and/or a fastener to be applied to increase the securement of the consumable components 204, 206, 208 to the torch body 202 and/or to one another. As such, the coupling of the consumable assembly 203 with the torch body 202 may be more easily achieved, such as without having to initially couple the consumable components 204, 206, 208 to one another before coupling to the torch body 202. The retention of the consumable components 204, 206, 208 to the torch body 202 may be particularly important if the torch body 202 is disposed in the depicted orientation during assembly of the consumable assembly 203 onto the torch body 202. In such an orientation, gravity may encourage the consumable components 204, 206, 208 to fall away from the torch body 202 until the consumable components 204, 206, 208 are fully installed in and secured to torch body 202. Thus, if some other component (e.g., a shield, a fastener) is used to secure the consumable components 204, 206, 208 to the torch body 202, a temporary coupling may hold the consumable components 204, 206, 208 in place on the torch body 202 prior to such securement.

It should be noted that any other suitable type of consumable component may be configured to independently couple to the torch body 202. By way of example, a shield may additionally or alternatively be configured to independently engage with the torch body 202 (e.g., to the fourth interface surface 226). Indeed, any suitable quantity of consumable components may be configured to couple to the torch body 202. To this end, the torch body 202 may include a suitable stepped profile (e.g., having a corresponding quantity of interface surfaces and/or axial surfaces) configured to receive the consumable components.

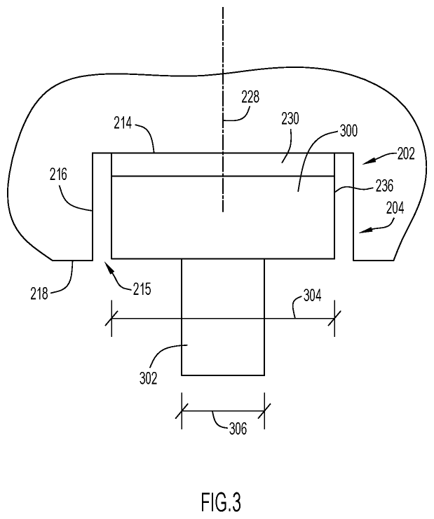

FIG. 3 is a schematic, cross-sectional view of the first consumable component 204 engaged and aligned with the torch body 202 according to aspects of the present application. As shown, the first consumable surface 230 of the first consumable component 204 abuts and sealingly engages with the first interface surface 214 of the torch body 202. The first consumable component 204 may have a base 300 and a distal portion 302 extending from the base 300. In the depicted embodiment, the base 300 includes a first dimension 304 (e.g., a first diameter), and the distal portion 302 includes a second dimension 306 (e.g., a second diameter) that is less than the first dimension 304.

In the illustrated embodiment, the base 300 is contained within the first receptacle 215. For example, the base 300 is positioned between the first axial surface 216 and extends from the first interface surface 214 to the second interface surface 218 along the axis 228, and the distal portion 302 extends from the base 300 beyond the second interface surface 218 along the axis 228. The alignment between the first consumable component 204 and the torch body 202 is dependent on the engagement of the first consumable component 204 with the torch body 202, rather than the positioning of other consumable components (e.g., the second consumable component 206, the third consumable component 208). For example, the distal portion 302 extends through, but does not engage with, the second consumable component 206 engaged with the second interface surface 218 and/or the third consumable component 208 engaged with the third interface surface 222. For this reason, potential misalignment between other consumable components and the torch body 202 may not cause misalignment of the first consumable component 204 with the torch body 202.

The second consumable component 206 and/or the third consumable component 208 may similarly be configured to engage with the torch body 202. That is, the alignment between the second consumable component 206 and the torch body 202 and/or between the third consumable component 208 and the torch body 202 is dependent on the respective engagements with the torch body 202, rather than the positioning of other consumable components. As such, a potential misalignment between any one of the consumable components 204, 206, 208 with the torch body 202 may not cause misalignment of another of the consumable components 204, 206, 208 with the torch body 202. For this reason, the torch body 202 may independently enable alignment of each of the consumable components 204, 206, 208. For example, engagement of the consumable components 204, 206, 208 with corresponding surfaces of the torch body 202 may correspondingly align the consumable components 204, 206, 208 with one another. Consequently, misalignment of the consumable components 204, 206, 208 with one another and/or with the torch body 202 may be more easily avoided to enable the arc processing torch 200 to operate more effectively and/or desirably (e.g., to provide more accurate and/or reliable cuts and/or welds).

Still referring to FIG. 3, with the depicted arrangement, a dimension of the base 300 may further help prevent misalignment. For instance, increased extension of the base 300 (e.g., in a distal direction away from the first interface surface 214) may enable a larger extent or portion of the first consumable component 204 to engage with the first axial surface 216 of the torch body 202. The increased engagement may provide increased stability and reduced relative movement between the first consumable component 204 and the torch body 202, which serves to avoid potential misalignment, e.g., from tilting, rotating, shifting, etc.

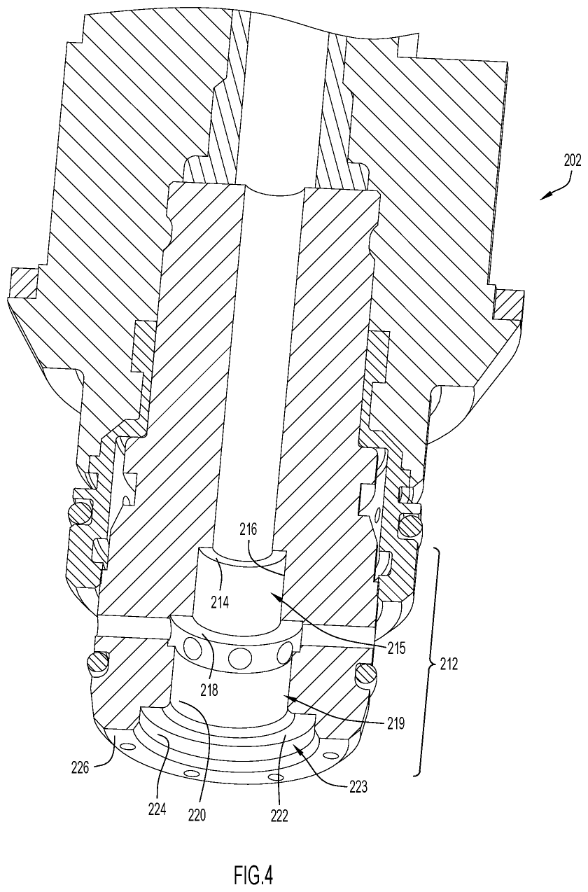

FIG. 4 is a perspective cross-sectional view of an embodiment of the torch body 202. The torch body 202 includes the first interface surface 214 and the first axial surface 216 cooperatively defining the first receptacle 215, the second interface surface 218 and the second axial surface 220 cooperatively defining the second receptacle 219, the third interface surface 222 and the third axial surface 224 cooperatively defining the third receptacle 223, and the fourth interface surface 226. The receptacles 215, 219, 223 cooperatively define the cavity 212 configured to receive the consumable assembly 203.

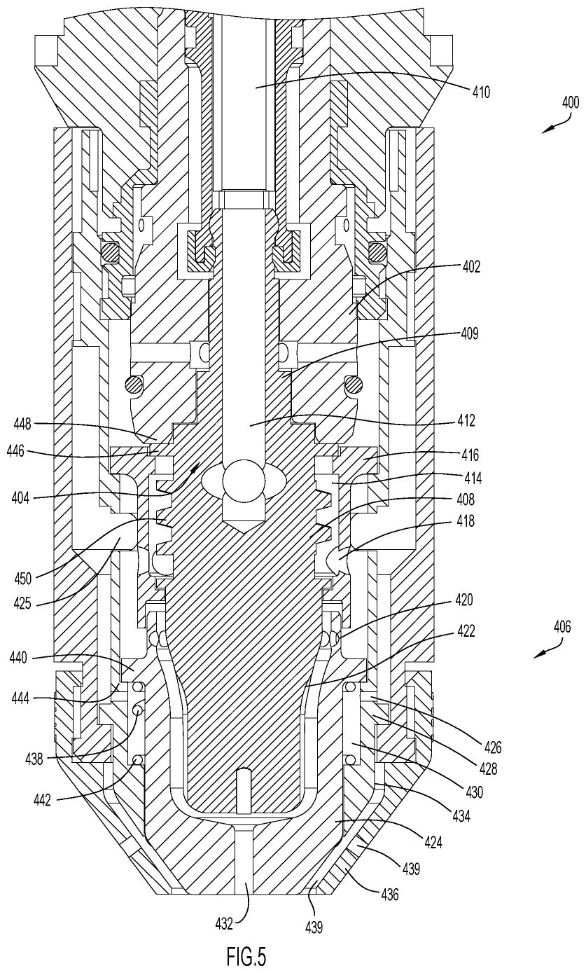

FIG. 5 is a front cross-sectional view of an embodiment of an arc processing torch 400 (e.g., a plasma cutting torch). The arc processing torch 400 includes a torch body 402, which may include a stepped profile that defines a cavity 404 similar to the cavity 212. However, the illustrated arc processing torch 400 includes a consumable assembly 406 with an electrode 408 (e.g., a cathode) configured to extend into the cavity 404 and engage with the surfaces (e.g., the interface surfaces, the axial surfaces) of the stepped profile defining the cavity 404. To this end, the electrode 408 includes an insert portion 409 that has differently sized diameters to form a corresponding stepped profile configured to engage with the stepped profile defining the cavity 404. In other words, the consumable assembly 406 may not include separate components configured to independently engage with the surfaces within the cavity 404. Additionally, the stepped profile of the consumable assembly 406 may use face seals (e.g., instead of separate seals, such as O-rings) to block undesirable flow of fluid between the torch body 402 and the consumable assembly 406.

As can be seen in FIG. 5, the illustrated consumable assembly 406 may direct fluid flow to establish and maintain an arc. For example, the torch body 402 includes a tube 410 configured to direct fluid flow into an electrode chamber 412 of the electrode 408. The electrode chamber 412 discharges the fluid flow into a passageway 414 formed between an electrode shell 416 and the electrode 408. Fluid flow may be discharged from the passageway 414 via one or more electrode shell openings 418 to split between a processing flow and a shield flow. The processing flow is directed through a distributor opening 420 and into a processing fluid flow channel 422 formed between the electrode 408 and a nozzle 424.

Meanwhile, the shield flow is directed through one or more shield flow openings 425 of a nozzle shell to a space between the nozzle shell 428 and the outer body of the arc processing torch 400 (e.g., a “shield cup”), where the shield flow can then be diverted to shield a processing stream and/or to act against a spring force imparted on the nozzle 424. Then, in the depicted embodiment, the shield flow may flow through one or more holes 426 of a nozzle shell 428 (e.g., an anode) and into a chamber 430 formed between the nozzle 424 and the nozzle shell 428. Once in the chamber 430, the shield flow may flow over and around a biasing member 438 (e.g., a spring) to cool the biasing member 438 before flowing between the nozzle shell 428 and the nozzle 424 into a shield flow channel 434 between the nozzle 424 and a shield 436. In the shield flow channel 434, the shield flow can exit the arc processing torch 400 to protect and constrict a processing stream emanating from nozzle 424.

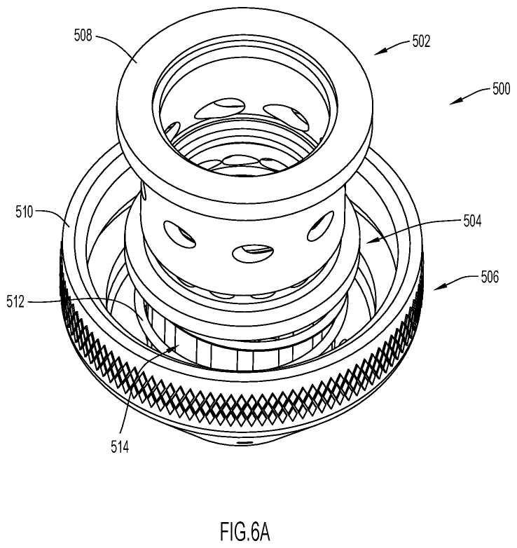

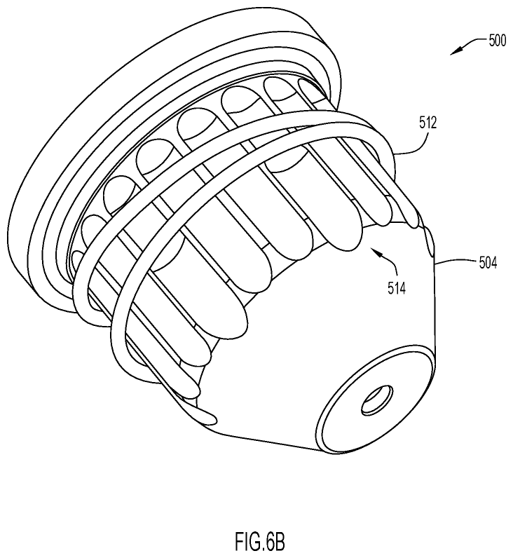

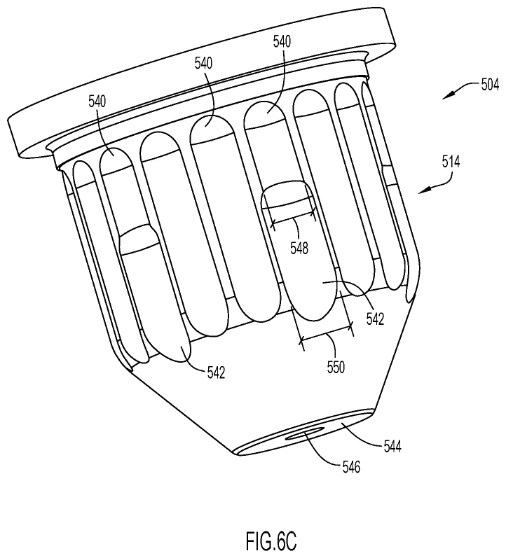

Still referring to FIG. 5, the depicted nozzle 424 includes an orifice 432 configured to discharge the processing flow from the arc processing torch 400. For example, the processing flow traverses an arc generated between the electrode 408 and the nozzle 424, and the processing flow discharged via the orifice 432 directs the arc through the orifice 432 and onto a workpiece. The nozzle 424 also includes channels or grooves (see FIGS. 6A-6C) that direct the shield flow from the chamber 430 into a shield flow channel 434 formed between a shield 436, the nozzle 424, and the nozzle shell 428. The shield 436 also forms shield openings 439 configured to discharge at least a portion of the shield flow around the arc directed through the orifice 432 to help protect and maintain the arc.

As alluded to above, in the depicted embodiment, the arc processing torch 400 includes a blow forward configuration in which the electrode 408 and the nozzle 424 are in contact with one another absent sufficient fluid flow through the consumable assembly 406 (e.g., while operation of the arc processing torch 400 is suspended). To this end, the consumable assembly 406 includes a biasing member 438 positioned within the chamber 430. The biasing member 438 may contact and exert a force against a nozzle flange 440 of the nozzle 424 and a shoulder 442 of the nozzle shell 428 to bias the nozzle 424 toward the electrode 408.

Contact between the nozzle 424 and the electrode 408 may initially block flow of processing fluid from the processing fluid flow channel 422 to the orifice 432. However, sufficient fluid flow through the consumable assembly 406 may cause the processing fluid directed through the electrode shell opening 418 (e.g., through the distributor opening 420, into the processing fluid flow channel 422) to exert a force against the nozzle 424 (e.g., against the nozzle flange 440, against a surface facing the processing fluid flow channel 422), such as by pressurizing within the processing fluid flow channel 422, to overcome the force exerted by the biasing member 438 against the nozzle flange 440. As a result, the nozzle 424 is driven out of contact with the electrode 408, such as to cause the nozzle flange 440 to engage with a lip 444 of the nozzle shell 428 (e.g., in the position shown in FIG. 5), thereby enabling flow of processing fluid from the processing fluid flow channel 422 to the orifice 432 to facilitate operation of the arc processing torch 400 (e.g., to direct an arc to a workpiece).

In addition, shield flow through the chamber 430 may cool the biasing member 438, thereby reducing wear of the biasing member 438 and increasing a useful lifespan of the biasing member 438. In some embodiments, the biasing member 438 includes a beryllium alloy, such as beryllium copper or beryllium titanium, to provide sufficient strength and resilience to bias the nozzle 424 and the electrode 408 away from one another. Indeed, the beryllium alloy composition of the biasing member 438 may have relatively greater thermal resistance as compared to other materials, such as steel (e.g., music wire), to provide improved performance and/or structural integrity. Thus, downtime of the arc processing torch 400, such as to inspect, replace, and/or repair the biasing member 438, may be reduced to improve operational efficiency of the arc processing torch 400. In additional or alternative embodiments, the biasing member 438 includes another suitable alloy, such as titanium copper, that contains desirable properties to improve performance and/or structural integrity.

In the illustrated embodiment, the electrode 408 further includes an electrode flange 446 configured to sealingly engage with an interface surface 448 (e.g., an exterior surface) of the torch body 402. The engagement between the electrode flange 446 and the interface surface 448 may block undesirable fluid flow between the electrode 408 and the torch body 402, thereby forcing fluid flow through the passageway 414 and the electrode shell opening 418. For example, the electrode 408 includes fins 450 extending within the passageway 414 and toward the electrode shell 416, and the engagement between the electrode flange 446 and the interface surface 448 may drive fluid flow across the fins 450 to cool the electrode 408, thereby reducing wear of the electrode 408 and increasing a useful lifespan of the electrode 408.

FIG. 6A is a perspective top view of a portion of a consumable assembly 500. In particular, the consumable assembly 500 includes an electrode shell 502 (e.g., configured to capture and receive an electrode), a nozzle 504 (e.g., coupled to the electrode shell 502), and a shield 506. In some embodiments, the electrode shell 502 and the nozzle 504 are configured to independently engage with a torch body (e.g., the torch body 202). For example, in the depicted embodiment the electrode shell 502 includes a first consumable surface 508 configured to engage with a first interface surface of the torch body, and the shield 506 includes a second consumable surface 510 configured to engage with a second interface surface of the torch body.

Engagement between the electrode shell 502 and the torch body may align the electrode shell 502 with the torch body, and engagement between the shield 506 and the torch body may align the shield 506 with the torch body. Further, engagement and alignment between the electrode shell 502 and the torch body may not affect engagement and alignment between the shield 506 and the torch body. As such, the electrode shell 502 and the shield 506 may be independently engaged and aligned with the torch body to provide desirable alignment of the consumable assembly 500 to the torch body and enable effective operation of an arc processing torch more easily. In additional or alternative embodiments, the electrode shell 502 and/or the shield 506 may be coupled to one another and/or to an electrode to provide the consumable assembly 500 configured to couple to the torch body.

The consumable assembly 500 also includes a biasing member 512, which is configured to bias the nozzle 504 and an electrode away from one another. The biasing member 512 may be composed of a beryllium alloy. The nozzle 504 also includes channels 514 (e.g., grooves, vanes, cutouts) through which fluid may flow. For example, in an assembled configuration of the consumable assembly 500, a nozzle shell may capture and surround the nozzle 504 to define a chamber (e.g., chamber 430) between the nozzle 504 and the nozzle shell. The channels 514 enable fluid flow between the nozzle 504 and the nozzle shell, such as to direct the fluid flow toward a shield. That is, the channels 514 may allow fluid in the chamber between the nozzle 504 and nozzle shell to exit the chamber and enter in a passageway between the nozzle 504 and a shield. As further discussed herein, the channels 514 may include a primary channel and a secondary channel that are of different sizes to direct fluid flow more desirably between the nozzle 504 and the nozzle shell.

FIG. 6B is a perspective side view of a portion of the consumable assembly 500. In particular, FIG. 6B illustrates the nozzle 504 and the biasing member 512, which surrounds and captures the nozzle 504. For example, the biasing member 512 helically extends around the nozzle 504 and across the channels 514 of the nozzle 504. Consequently, fluid flow directed through the channels 514 may flow across the biasing member 512, thereby providing cooling of the biasing member 512 to maintain a structural integrity of the biasing member 512.

FIG. 6C is a perspective side view of the nozzle 504. As mentioned, the nozzle 504 has the channels 514 that include primary channels 540 (e.g., primary channel portions). Some of the primary channels 540 are also connected to secondary channels 542 (e.g., secondary channel portions). That is, the secondary channels 542 extend from the primary channels 540, such as toward a distal surface 544 of the nozzle 504, which has an orifice 546. In the depicted embodiment, the primary channels 540 and the secondary channels 542 are differently sized. For example, the primary channels 540 include a first dimension 548 (e.g., a first width), and the secondary channels 542 include a second dimension 550 (e.g., a second width) that is greater than the first dimension 548. Thus, the secondary channels 542 extend laterally or circumferentially beyond the primary channels 540. In other words, the secondary channels 542 encompass a greater arc length or circumferential portion of the perimeter of the nozzle 504 as compared to that encompassed by the primary channels 540. Additionally or alternatively, the secondary channels 542 may have a greater depth than that of the primary channels 540. In other words, the secondary channels 542 may inwardly extend deeper into the nozzle 504, such as more adjacent to a part of the orifice 546 extending through the nozzle 504.

The primary channels 540 may help maintain alignment of the nozzle 504 (e.g., with respect to the electrode shell 416). For example, each primary channel 540 may face (e.g., extend along) the chamber (e.g., chamber 430) such that shield flow discharged from the chamber via the channels 514 are initially directed through a primary channel 540. The primary channels 540 may be evenly distributed around the nozzle 504 such that a force exerted by the shield flow impinging against the nozzle 504 (e.g., against the primary channels 540) is also evenly distributed around the nozzle 504. Even distribution of the force about the nozzle 504 may avoid, or at least limit, movement of the nozzle 504 caused by shield flow across the nozzle 504, thereby maintaining desirable positioning and alignment associated with the nozzle 504.

The secondary channels 542 may help increase shield flow between the nozzle 504 and the surrounding nozzle shell, thereby increasing discharge of shield flow from the chamber (e.g., chamber 430) formed between the nozzle 504 and the nozzle shell. As a result, pressurization within the chamber may be limited, such as maintained below a threshold pressure, and/or the shield flow may be directed at a desirable speed toward the shield. In some embodiments, the secondary channels 542 may also be evenly distributed around the nozzle 504 to block movement of the nozzle 504 and maintain desirable positioning and alignment associated with the nozzle 504. Additionally, in certain embodiments, the secondary channels 542 may not face the chamber. Instead, for instance, the secondary channels 542 may face (e.g., extend along) a portion of the nozzle shield that is directly in contact with the nozzle 504, rather than alongside the chamber formed by an offset of the nozzle shield from the nozzle 504. Thus, fluid flow may be directed sequentially from the primary channels 540 to the secondary channels 542 extending from the primary channels 540 to flow between the nozzle 504 and the nozzle shell.

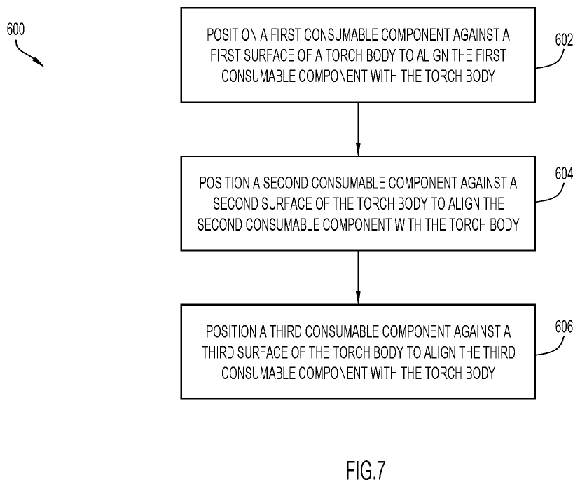

FIG. 7 is a flowchart of a method 600 of assembling or manufacturing an arc processing torch (e.g., a plasma cutting torch), such as the arc processing torch 200. In some embodiments, the method 600 may be performed manually, such as by a technician or operator. In additional or alternative embodiments, the method 600 may be performed automatically. It should be noted that the method 600 may be performed in a different manner than depicted. For example, an additional operation may be performed, and/or any of the depicted operations may be performed differently, performed in a different order, or not performed.

At block 602, a first consumable component is positioned against a first surface of a torch body to align the first consumable component with the torch body. For example, the first consumable component is inserted into a cavity (e.g., a first receptacle of the cavity) defined by the torch body to engage with a first interface surface and/or with first axial surfaces of the torch body within the cavity. In at least some embodiments, the first consumable component is an electrode.

At block 604, a second consumable component is positioned against a second surface of a torch body to align the second consumable component with the torch body. As an example, the second consumable component is inserted into the cavity (e.g., a second receptacle of the cavity) to engage with a second interface surface and/or with second axial surfaces of the torch body within the cavity. In at least some embodiments, the second consumable component is a distributor and/or insulator. Alternatively, the second consumable component may be a nozzle.

At block 606, a third consumable component is positioned against a third surface of a torch body to align the third consumable component with the torch body. As an example, the third consumable component is inserted into the cavity (e.g., a third receptacle of the cavity) to engage with a third interface surface and/or with third axial surfaces of the torch body within the cavity. In at least some embodiments, the third consumable component is a nozzle.

In some embodiments, the first consumable component, the second consumable component, and the third consumable component are positioned against the corresponding surfaces of the torch body without having to be positioned in engagement with one another. Accordingly, each consumable component may independently engage and align with the torch body. That is, engagement of one of the consumable components with the torch body may not affect alignment between another one of the consumable components with the torch body. Thus, assembly of the consumable components may be more easily performed, and/or desirable alignment of the consumable components with the torch body may be more easily achieved, such as by enabling the consumable components to be individually engaged with the torch body. However, in other embodiments, some consumables may align on each other while others independently align with the torch body.

After the consumable components are positioned against the torch body, securement of the consumable components to the torch body may be increased to complete assembly of the arc processing torch. In certain embodiments, positioning of the consumable components against the respective surfaces of the torch body may retain an alignment of the consumable components with the torch body. By way of example, a magnetic engagement between the consumable components and the torch body, a detent pin, an interference fit, and/or a collet lock may temporarily hold the consumable components in alignment with the torch body and enable a more durable securement feature to be applied to couple the consumable components to the torch body. Consequently, desirable coupling (e.g., fixed securement) of the consumable components to the torch body may be achieved.

While the arc processing torch features presented herein have been illustrated and described in detail and with reference to specific embodiments thereof, it is nevertheless not intended to be limited to the details shown, since it will be apparent that various modifications and structural changes may be made therein without departing from the scope of the disclosures and within the scope and range of equivalents of the claims. For example, as mentioned, the consumable components presented herein may be modified to connect to or be used with any other desired consumable or non-consumable components, including to facilitate a specific arc initiation technique. Additionally, the consumables presented herein may be suitable for automated (e.g., mechanized) and/or manual (e.g., handheld) systems.

In addition, various features from one of the embodiments may be incorporated into another of the embodiments. That is, it is believed that the disclosure set forth above encompasses multiple distinct disclosures with independent utility. While each of these disclosures has been disclosed in a preferred form, the specific embodiments thereof as disclosed and illustrated herein are not to be considered in a limiting sense as numerous variations are possible. The subject matter of the disclosures includes all novel and non-obvious combinations and subcombinations of the various elements, features, functions, and/or properties disclosed herein. Accordingly, it is appropriate that the appended claims be construed broadly and in a manner consistent with the scope of the disclosure as set forth in the following claims.

It is also to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points of reference and do not limit the present disclosure to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the disclosure. Additionally, it is also to be understood that the consumables described herein, or portions thereof may be fabricated from any suitable material or combination of materials, such as plastic or metals (e.g., copper, bronze, hafnium, etc.), as well as derivatives thereof, and combinations thereof.

Finally, when used herein, the term “comprises” and its derivations (such as “comprising”, etc.) should not be understood in an excluding sense, that is, these terms should not be interpreted as excluding the possibility that what is described and defined may include further elements, steps, etc. Similarly, where any description recites “a” or “a first” element or the equivalent thereof, such disclosure should be understood to include incorporation of one or more such elements, neither requiring nor excluding two or more such elements. Meanwhile, when used herein, the term “approximately” and terms of its family (such as “approximate,” etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc.). For example, the term “approximately” may denote a tolerance of plus or minus 0.002 inches, 0.001 inches, or up to 0.005 inches. The same applies to the terms “about” and “around” and “substantially.”

What is claimed is:

1. An arc processing torch, comprising:
a torch body having a first interface surface and a second interface surface to form a stepped profile defining a cavity; and
a plurality of consumable components including:
a first consumable component configured to be positioned within the cavity to engage with the first interface surface; and
a second consumable component configured to be positioned within the cavity to engage with the second interface surface,
wherein the first consumable component and the second consumable component are configured to independently engage with the first interface surface and the second interface surface, respectively.

2. The arc processing torch of claim 1, wherein the torch body comprises an axial surface extending between the first interface surface and the second interface surface, and the first consumable component is configured to be positioned between opposite sides of the axial surface to engage with the first interface surface.

3. The arc processing torch of claim 2, wherein the first interface surface and the axial surface cooperatively define a receptacle configured to receive the first consumable component, and engagement of the second consumable component with the second interface surface positions the second consumable component exteriorly of the receptacle.

4. The arc processing torch of claim 2, wherein the axial surface is a first axial surface, the torch body comprises a second axial surface extending distally from the second interface surface, and the second consumable component is configured to be positioned between opposite sides of the second axial surface to engage with the second interface surface.

5. The arc processing torch of claim 4, wherein the first consumable component is configured to extend at least partially between the second interface surface while positioned in engagement with the first interface surface.

6. The arc processing torch of claim 1, wherein the torch body comprises a third interface surface, the plurality of consumable components comprises a third consumable component configured to be positioned within the cavity to engage with the third interface surface, and the first consumable component, the second consumable component, and the third consumable component are configured to independently engage with the first interface surface, the second interface surface, and the third interface surface, respectively.

7. The arc processing torch of claim 1, wherein the second consumable component comprises a nozzle, the arc processing torch comprises a nozzle shell surrounding the nozzle to form a chamber between the nozzle and the nozzle shell, and the nozzle comprises a plurality of channels configured to discharge fluid flow from the chamber.

8. The arc processing torch of claim 7, wherein the plurality of channels comprises a first channel and a second channel extending from the first channel toward a distal surface of the nozzle, and the second channel extends circumferentially beyond the first channel.

9. The arc processing torch of claim 8, wherein the first channel faces the chamber, and the second channel faces a portion of the nozzle shell directly in contact with the nozzle.

10. A method of assembling an arc processing torch, comprising:
inserting a first consumable component of the arc processing torch within a cavity defined by a torch body of the arc processing torch to position the first consumable component against a first surface of the torch body;
inserting a second consumable component of the arc processing torch within the cavity to position the second consumable component against a second surface of the torch body; and
inserting a third consumable component of the arc processing torch within the cavity to position the third consumable component against a third surface of the torch body.

11. The method of claim 10, wherein positioning the first consumable component against the first surface of the torch body and positioning the second consumable component against the second surface of the torch body position the first consumable component to extend through an opening of the second consumable component, positioning the first consumable component against the first surface of the torch body and positioning the third consumable component against the third surface of the torch body position the first consumable component to extend through an opening of the third consumable component, or both.

12. The method of claim 10, wherein positioning the first consumable component against the first surface of the torch body sealingly engages the first consumable component with the first surface of the torch body, positioning the second consumable component against the second surface of the torch body sealingly engages the second consumable component with the second surface of the torch body, positioning the third consumable component with the third surface of the torch body sealingly engages the second consumable component against the third surface of the torch body, or any combination thereof.

13. The method of claim 10, wherein positioning the first consumable component against the first surface temporarily retains a position of the first consumable component with respect to the torch body, positioning the second consumable component against the second surface temporarily retains a position of the second consumable component with respect to the torch body, positioning the third consumable component against the third surface temporarily retains a position of the third consumable component with respect to the torch body, and the method comprises increasing securement of the torch body to the first consumable component, the second consumable component, and the third consumable component at their respective positions with respect to the torch body.

14. An arc processing torch, comprising:
a torch body that includes:
a first interface surface;
an axial surface that extends distally from the first interface surface; and
a second interface surface that extends laterally beyond the first interface surface;
a first consumable component configured to engage with the first interface surface; and
a second consumable component configured to engage with the second interface surface.

15. The arc processing torch of claim 14, wherein the torch body comprises:
an additional axial surface that extends distally from the second interface surface; and
a third interface surface that extends laterally beyond the second interface surface.

16. The arc processing torch of claim 15, comprising a third consumable component configured to engage with the third interface surface.

17. The arc processing torch of claim 14, wherein the first consumable component and the second consumable component do not engage with one another.

18. The arc processing torch of claim 14, wherein the first consumable component comprises an electrode, and the second consumable component comprises a distributor.

19. The arc processing torch of claim 14, wherein the first consumable component comprises an electrode, the second consumable component comprises a nozzle, the arc processing torch comprises a spring configured to bias the nozzle and the electrode away from one another, wherein the spring is composed of a beryllium alloy.

20. The arc processing torch of claim 14, wherein the second consumable component comprises a nozzle, the arc processing torch comprises a nozzle shell surrounding the nozzle to form a chamber between the nozzle and the nozzle shell, the nozzle comprises a first channel and a second channel configured to discharge fluid flow from the chamber, the second channel extends distally from the first channel, and the second channel extends deeper into the nozzle than the first channel extends into the nozzle.
